(19) United States
(12) Patent Application Publication
(10) Pub. No.: US 2004/0259416 A1
(43) Pub. Date: Dec. 23, 2004

(54) Connector for coaxial cable and electronic device case

(75) Inventors: Wataru Kodama, Nisshin-Shi (JP); Yoshiji Hattori, Nisshin-Shi (JP); Takashi Tamezane, Nisshin-Shi (JP); Toshihiro Sugiura, Nisshin-Shi (JP)

Correspondence Address: BURR & BROWN, PO BOX 7068, SYRACUSE, NY, 13261-7068, US

(73) Assignee: Maspro Denkoh Co., Ltd., Nisshin-Shi (JP)

(21) Appl. No.: 10/867,122

(22) Filed: Jun. 14, 2004

(30) Foreign Application Priority Data
Jun. 20, 2003 (JP) 2003-177146
Nov. 5, 2003 (JP) 2003-376204
May 21, 2004 (JP) 2004-152371

(51) Int. Cl. H01R 9/05

(52) U.S. Cl. 439/578

(57) ABSTRACT

The invention provides a connector for coaxial cable which prevents a fall-out of the coaxial cable and has a release function. A sleeve 6 for penetrating between the inner insulator 7b and the outer conductor 7c of the coaxial cable 7, a stopper 3 for preventing the fall-out the coaxial cable 7, and a releaser 5 for releasing the stopper's locking force of the coaxial cable 7 are provided within the main body of the connector 1 to which the coaxial cable is inserted. The stopper 3 has elastic property in diameter, and an inner peripheral portion of the distal end thereof serves as the supporting portion 3a for the coaxial cable and the outer peripheral portion of the distal end thereof serves as the fastening portion 3b for the stopper, hence to support the coaxial cable 7 and prevent the fall-out of the same.

### BACKGROUND OF THE INVENTION

This application claims the benefit of Japanese Patent Application Number 2003-177146 filed Jun. 20, 2003 and Japanese Patent Application Number 2003-376204 filed Nov. 5, 2003, and Japanese Patent Application Number 2004-152371 filed May 21, 2004, the entirety of which is incorporated by reference.

### FIELD OF THE INVENTION

The present invention relates to a connector for coaxial cable for connecting the coaxial cables together or connecting the coaxial cable with a chassis of an electronic device, and a case for an electronic device capable of directly connecting the coaxial cable.

### DESCRIPTION OF THE RELATED ART

When attaching a connector to a coaxial cable, hitherto there has been widely adopted a method of crimping a ring portion integrated with ferrule or shell with pliers or a special tool in order to prevent a drop of the cable (for example, refer to the related art of Japanese Patent publication of unexamined application No. 11-288767).

This method is troublesome, however, because a connector has to be attached by being crimped with some tools. Therefore, as described in Japanese Patent publication of unexamined application No. 11-288767 (FIG. 10), the structure of a connector is known, in which an inner claw portion is provided in the inner cylindrical portion and an outer claw portion is provided in the outer cylindrical portion so as to lodge a coaxial cable within the connector only by insertion. Moreover, as described in Japanese Patent publication of unexamined application No. 2002-184536 (FIG. 7) that the present applicant filed before, the structure of a slip-free connector without necessity of any crimping tool is known, in which a ring-shaped stopper having a claw is outwardly attached to a coaxial cable so that the claw can bite into the cable, in order to prevent the slip, or the structure of a case for an electronic device having the same terminal is known.

However, the techniques disclosed in the above Patent Documents does not include a release function, so it is difficult to remove the coaxial cable once mounted. Moreover, when changing the coaxial cable, a new connector is required, and when changing the length of the coaxial cable, it is necessary to cut off the connector portion of the cable and attach another connector. As for an electronic device case, there is no way but to exchange the case itself, and the connector and the case cannot be recycled, which is wasteful.

Therefore, in consideration for the above problem, the present invention aims to provide a coaxial cable connector and an electronic device case preventing a fall-out of a coaxial cable and having a release function.

### SUMMARY OF THE INVENTION

In order to solve the above problem, the invention according to a first aspect provides a connector for coaxial cable having a cylindrical main body into which a coaxial cable is inserted, and connecting means provided in front of the main body to connect the main body with a connecting object. The main body includes a sleeve penetrating between an inner insulator and an outer conductor of the coaxial cable to be inserted and a stopper for preventing a fall-out of the coaxial cable therein. The stopper is formed in substantially cone shape with the front portion narrower. The stopper has an inner peripheral portion of the distal end thereof serving as a supporting portion for supporting the circumference of the coaxial cable, and an outer peripheral portion of the distal end thereof serving as a fastening portion to fasten the stopper within the main body of the connector. At least the supporting portion has elastic property in diameter, and the supporting portion supports the coaxial cable and prevents the fall-out of the coaxial cable when an end of the coaxial cable is inserted into the main body of the connector from backward.

This structure can prevent the fall-out of the coaxial cable inserted into the connector by means of the function of the stopper even when a drawing stress is applied, and the cable can be assuredly attached in the connector. When the end portion of the coaxial cable is formed into a predetermined shape and inserted into the main body of the connector, it is easy to attach the connector since the connector portion is completed after attachment of the connector.

The invention according to a second aspect provides the connector for coaxial cable according to the first aspect, wherein the supporting portion of the stopper is formed in such a way that the distal end thereof makes a line contact with the coaxial cable.

This structure can support the coaxial cable assuredly and improve the locking force.

The invention according to a third aspect provides the connector for coaxial cable according to the first aspect, comprising a releaser for releasing the stopper's locking force toward the coaxial cable, including a cylindrical sliding portion for covering the coaxial cable and an operating portion for operating the sliding portion. The distal end of the sliding portion abuts on the supporting portion of the stopper and pushes up the supporting portion by sliding the sliding portion forward, hence to release a supporting operation of the coaxial cable.

This structure can release the blocking function of the stopper by operating the releaser and pull out the cable easily. Therefore, the cables can be exchanged easily. Further, the inserted coaxial cable can be pulled out only by an easy operation of pushing the releaser and the releaser is formed in a simple structure.

The invention according to a fourth aspect provides the connector for coaxial cable according to the first aspect, wherein processing for blocking the coaxial cable is performed on a periphery of the sleeve.

This structure can prevent the fall-out of the coaxial cable assuredly in combination with the stopper.

The invention according to a fifth aspect provides to the connector for coaxial cable according to the first aspect, comprising a rotation-stopping means which prevents rotation of the inserted coaxial cable.

This structure can prevent the inserted coaxial cable from rotating together with the connector and keep a good connection.

The invention according to a sixth aspect provides the connector for coaxial cable according to the fifth aspect, in which the rotation-stopping means is a strip-shaped projection longitudinally formed on the side surface of the sleeve, which prevents rotation of the inserted cable.

According to this structure, the rotation of the coaxial cable can be prevented in a simple structure, without providing a separate component.

The invention according to a seventh aspect provides the connector for coaxial cable according to the first aspect, wherein the rear end of the sleeve is located posterior to the supporting portion of the stopper.

According to this structure, even if a coaxial cable with a small diameter is inserted due to an inconsistent diameter of a coaxial cable, an inner diameter of the protective covering at a portion supported by the stopper can be maintained at a predetermined size since the inner diameter is expanded by the sleeve. As a result, a diameter of the portion supported by the stopper is not narrowed, and thus it is possible to support the protective covering preferably. In addition, even if a coaxial cable with a different diameter is used, power to pull out the coaxial cable can be maintained over a predetermined value, resulting that the coaxial cable is not fallen out. Moreover, with the stopper surrounding the sleeve, the entire length of the main body of the connector can be shortened.

The invention according to an eighth aspect provides the connector for coaxial cable according to the seventh aspect, wherein ring-shaped projections are formed at the back of the sleeve for blocking the coaxial cable.

According to this structure, the ring-shaped projection 37 expands the protective covering 7d behind the supporting portion by the stopper 3, so that the locking force is improved and the fall-out of the coaxial cable is prevented assuredly.

The invention according to a ninth aspect provides the connector for coaxial cable according to the sixth aspect, wherein the rotation-stopping means is a cylindrical latch through which the inserted coaxial cable penetrates, the cylindrical latch is arranged so as to cover the sleeve and includes the front portion engaged into the main body of the connector and has elastic property in diameter, and a latching blade is provided in its inner surface for biting into the circumference of the coaxial cable. The latching blade is arranged in parallel with a central axis of the connector and toward the above central axis, hence to bite into the circumstance of the inserted coaxial cable and prevent rotation of the coaxial cable.

According to this structure, the latching blade bites into the protective covering of the coaxial cable linearly, thereby prevent the rotation of the coaxial cable assuredly.

The invention according to a tenth aspect provides the connector for coaxial cable according to the ninth aspect, wherein the latching blade protrudes such that it bites into a protective covering by 10 to 20% of thickness of the protective covering.

According to this structure, the coaxial cable can be assuredly latched by the latching blade, hence to be prevented from the rotation, without breaking the protective covering.

The invention according to an eleventh aspect provides the connector for coaxial cable according to the first aspect, in which the connecting means is a nut female-screwed on the inner surface, and a cylindrical fitting portion on which the nut is fit protrudes in front of the main body of the connector in order to support the rear portion of the nut in a rotatable way. Moreover, in the cylindrical fitting portion a through hole is provided through which the inner insulator and the central conductor of the inserted coaxial cable penetrate in series with the sleeve. The central conductor of the inserted coaxial cable protrudes from the through hole to be arranged on the central axis of the nut.

According to this structure, it is possible to attach the plug terminal to the connector only by forming the end portion of the coaxial cable into a predetermined shape, hence to connect with the receptacle terminal of the electronic device.

The invention according to a twelfth aspect provides the connector for coaxial cable according to the first aspect, in which the connecting means is a male-screwed bolt integrated with the main body of the connector, and on the central axis of the bolt, a communication hole is formed for jointing the central conductor of the coaxial cable attached to the main body of the connector with the central conductor of the connecting object, and a fitting metal for jointing and supporting the both central conductors is arranged within the communication hole.

According to this structure, it is possible to attach the receptacle terminal only by forming the end portion of the coaxial cable into a predetermined shape, hence to connect with the plug terminal easily. Accordingly, the both coaxial cables can be connected with each other assuredly.

The invention according to a thirteenth aspect provides the connector for coaxial cable according to the first aspect, in which the connecting means is formed symmetrically with the main body of the connector, the two main bodies are opposed to each other and integrated into one body, the sleeves and the stoppers are also arranged within the both main bodies symmetrically, and a fitting metal for jointing the both central conductors of the coaxial cables inserted into the both main bodies with each other is arranged in the middle portion.

According to this structure, it is possible to obtain the cable relay connector which directly connects the both cables and joint the both cables easily only by cutting the end portions of the cables into predetermined shape and inserting the cables in the main body. Further, the cable can be pulled out easily by operating the releaser.

The invention according to a fourteenth aspect provides an electronic device case having a connector for coaxial cable attached from outside, in which the connector for coaxial cable has a cylindrical main body of connector into which the coaxial cable is inserted, including a sleeve inserted between an inner insulator and an outer conductor of the coaxial cable to be attached and a stopper for preventing the fall-out of the coaxial cable, the stopper is formed in substantially cone shape with the front portion narrower, in which the inner peripheral portion of the distal end thereof serves as a supporting portion for supporting the circumference of the coaxial cable, and the outer peripheral portion of the distal end thereof serves as a fastening portion to fasten the stopper within the main body of the connector, and at least the supporting portion has elastic property in diameter, and by inserting an end of the coaxial cable into the main body of the connector from backward, the cable is attached to the case and the supporting portion supports the coaxial cable, hence to prevent the drop-out of the coaxial cable.

This structure can prevent the fall-out of the coaxial cable provided in the case even when a drawing stress is applied because of the function of the stopper, and the cable can be assuredly attached. The coaxial cable can be directly connected to the case because of an easy operation of forming the end portion of the coaxial cable into a predetermined shape and inserting it into the main body of the connector without necessity of attaching a separate connector to the coaxial cable.

The invention according to a fifteenth aspect provides the case for electronic device according to the fourteenth aspect, in which the supporting portion of the stopper is formed in such a way that the distal end thereof makes a line contact with the coaxial cable.

This structure can support the coaxial cable assuredly and improve the locking force.

The invention according to a sixteenth aspect provides the electronic device case according to the fourteenth aspect, further comprising a releaser for releasing the stopper's locking force of the coaxial cable, including a cylindrical sliding portion for covering the coaxial cable and an operating portion for operating the sliding portion, in which a distal end of the sliding portion abuts on the supporting portion of the stopper and pushes up the supporting portion by sliding the sliding portion in a direction of the case, hence to release a supporting operation of the coaxial cable.

According to this structure, the blocking function of the stopper can be released by operating the releaser and the cable can be pulled out easily. Accordingly, the cables can be exchanged easily. The inserted coaxial cable can be pulled out by an easy operation of pushing the releaser and the releaser can be formed in a simple structure.

The invention according to a seventeenth aspect provides the case for electronic device according to the fourteenth aspect, further comprising the rotation-stopping means for preventing rotation of the inserted coaxial cable on at least one of the sleeve and an abutting surface of the main body of the connector abutting on the inserted coaxial cable.

This structure can prevent the inserted coaxial cable from rotating together with the connector and keep a favorable connection.

The invention according to an eighteenth aspect provides the electronic device case according to the seventeenth aspect, in which the rotation-stopping means is a strip-shaped projection longitudinally formed on the side surface of the sleeve in a direction of axis of the sleeve, which prevents rotation of the inserted cable.

By forming the rotation-stopping means accordingly, the rotation of the coaxial cable can be prevented in a simple structure, without providing a separate component.

The invention according to the nineteenth aspect provides the electronic device case according to the fourteenth aspect, in which the rear end of the sleeve is located posterior to the supporting portion of the stopper.

According to this structure, even is a coaxial cable with a different diameter is used, an inner diameter of the protective covering at a portion supported by the stopper can be maintained at a predetermined size since it is expanded by the sleeve. As a result, the stopper supports the protective covering assuredly and the fall-out of the coaxial cable is prevented.

The invention according to the twentieth aspect provides the electronic device case according to the nineteenth aspect, in which ring-shaped projection is formed at the rear end of the sleeve and the projection is located just behind the stopper.

According to this structure, the protective covering is expanded just behind a portion supported by the stopper, so that locking force is improved.

As mentioned above, according to the connector for coaxial cable of the invention, the coaxial cable inserted into the connector can be prevented from falling out even when a drawing stress is applied due to the function of the stopper, and it can be assuredly attached. On the other hand, the blocking function of the stopper can be released by operating the releaser and the cable can be pulled out easily. Therefore, the cables can be exchanged easily. The coaxial cable, in an attached state, is prevented from rotation even in the pull-out capable structure, kept in a good connection with the connector. The attachment of the connector is completed only by forming the end portion of the coaxial cable into a predetermined shape and inserting it into the main body of the connector, which is an easy operation.

According to the electronic device case of the invention, the coaxial cable attached within the case can be prevented from dropping out even when a drawing stress is applied due to the function of the stopper and it can be assuredly attached. On the other hand, since the blocking function of the stopper can be released by operating the releaser, the cables can be exchanged at ease. The attachment of the connector to the case is completed only by forming the end portion into a predetermined shape and inserting it into the main body of the connector and the attachment of the coaxial cable is easy.

### BRIEF DESCRIPTION OF THE DRAWINGS

FIG. 1 shows a first embodiment of a connector for coaxial cable according to the invention, and it is a side lateral view showing the connector for coaxial cable in partial cross section when inserting a coaxial cable into the connector and an enlarged view of A portion.

FIG. 2 is a perspective view of a sleeve of FIG. 1.

FIG. 3 shows a stopper of FIG. 1. FIG. 3A is a front view and FIG. 3B is a cross sectional view taken on the line B-B.

FIG. 4 is a side lateral view of the connector for coaxial cable of FIG. 1 before inserting a coaxial cable into the connector.

FIG. 5 is a side lateral view of the connector for coaxial cable of FIG. 1 on the way of inserting a coaxial cable into the connector.

FIG. 6 shows a second embodiment of a connector for coaxial cable according to the invention and it is a side lateral view showing a partial cross section.

FIG. 7 is a side lateral view of the connector for coaxial cable of FIG. 6 before inserting a coaxial cable into the connector.

FIG. 8 shows a latch of FIG. 6. FIG. 8A is aside lateral view showing a partial cross section and FIG. 8B is a front view.

FIG. 9 shows a third embodiment of a connector for coaxial cable according to the invention, and it is a side lateral view showing a partial cross section.

FIG. 10 is a side lateral view showing another connector for coaxial cable in partial cross section according to the invention.

FIG. 11 is a perspective view of a sleeve showing another example of the rotation-stopping means.

FIG. 12 shows a fourth embodiment of a connector for coaxial cable according to the invention, and it is a cross sectional view showing a state in which the coaxial cable is inserted.

FIG. 13A shows a state before inserting the coaxial cable into the connector for coaxial cable of FIG. 12, and FIG. 13B shows a state in which the stopper bites the protective covering when drawing stress is applied to the coaxial cable inserted into the connector.

FIG. 14 shows a modification of the fourth embodiment, and it is a cross sectional view of a state in which the coaxial cable is inserted.

FIG. 15 is an explanatory cross sectional view showing one example of a case for an electronic device according to the invention.

FIG. 16 is a perspective view showing another example of the sleeve of FIG. 1.

### DESCRIPTION OF THE PREFERRED EMBODIMENT

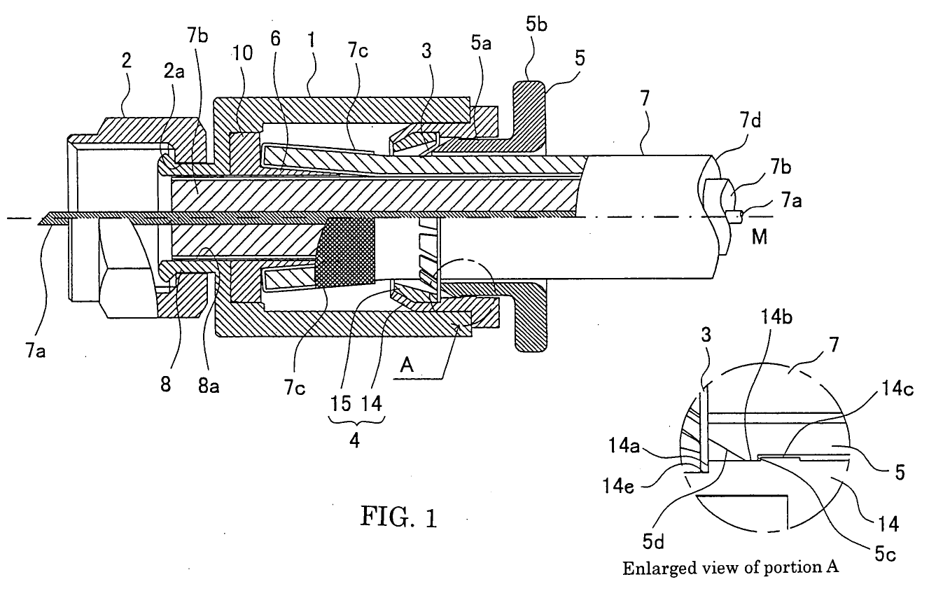

Hereinafter, embodiments of the invention will be described in detail according to the drawings. FIG. 1 shows the first embodiment of a coaxial cable connector (hereafter, referred to as a connector simply) related to the invention, and it is an explanatory view showing an important portion of the connector mounted in the coaxial cable, with its partly-enlarged view.

In FIG. 1, the reference numeral 1 indicates a main body of the cylindrical connector, including cable-attaching means, for covering a coaxial cable (hereafter, referred to as a cable simply) and the reference numeral 2 indicates a nut as a connecting means for connecting the cable to a connecting object such as a receptacle. The cable-attaching means includes a stopper 3 for preventing fall-out of the inserted cable, an anchor 4 for fixing the stopper 3, a releaser 5 for releasing the lock function of the stopper 3, and a sleeve 6 to be inserted between an inner insulator 7b and an outer conductor 7c of the cable 7 to be attached, and the description will be made with the left direction defined as the front in this figure. The reference numeral 7a indicates a central conductor and the reference numeral 7d indicates a protective covering of the cable.

The main body of the connector 1 has a cable inserting portion at the rear side, and a cylindrical fitting portion 8 at the front side. The cylindrical fitting portion 8 protrudes with a small diameter so that the nut is fit in the same. Moreover, in the cylindrical fitting portion 8a there is a through hole 8a through which the inner insulator 7b and the central conductor 7a of the cable 7 penetrate. The nut 2 includes a female screw on its inner surface and a joint hole 2a where the cylindrical fitting portion 8 of the main body 1 is inserted at the rear portion. As a result, the nut 2 can be attached to the front of the main body of the connector 1 in a rotatable way. The distal end portion of the cylindrical fitting portion 8 expands in diameter after jointing with the nut 2, thereby preventing the nut 2 from falling out.

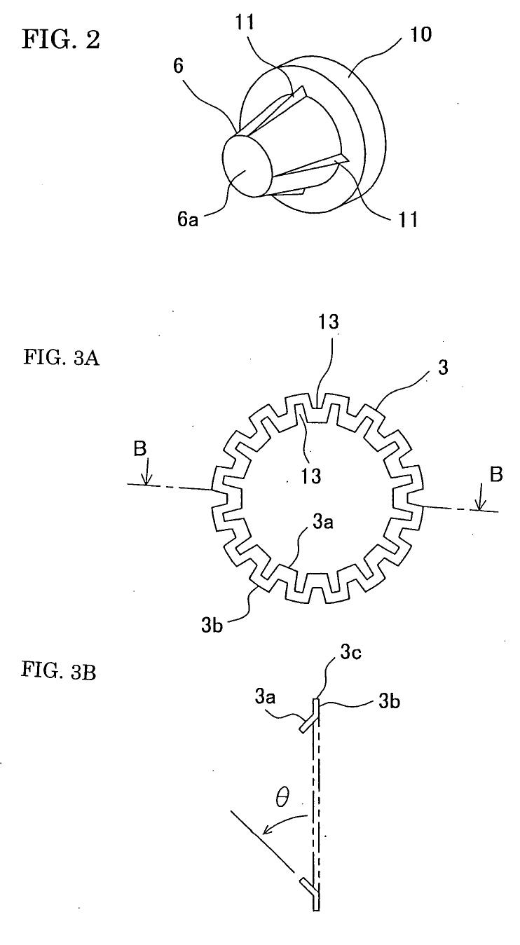

FIG. 2 shows a rear perspective view of the sleeve 6. As illustrated in FIG. 2, the sleeve 6 is formed at the back of a ring-shaped jointing portion 10 integrally with the same for jointing the sleeve 6 with the main body of the connector 1. The sleeve 6 is formed in a conically-shape, having a wall thickness tapering down backwardly from the jointing portion. Here, a through hole 6a has the same diameter from the jointing portion to the tapered end. This shape makes it easy to penetrate the sleeve between the inner insulator 7b and the outer conductor 7c of the cable 7.

A plurality of linear strip-shaped projections 11 are provided across the side surface of the sleeve 6, starting from the ring-shaped jointing portion 10 to the backward end portion, as the rotation-stopping means. The strip-shaped projections 11 are tapered from the ring-shaped jointing portion 10 to the end, similarly to the sleeve 6.

Only one strip-shaped projection 11 may be provided, or it may be formed not on the whole side surface from the base of the sleeve 6 to its backward end but on one portion of the side surface. The through hole 6a of the sleeve 6 has the same diameter as the through hole 8a formed on the cylindrical fitting portion 8 in the front portion of the main body of the connector 1 on the central axis M of the connector, or the sleeve 6 may be formed integrally with the main body of the connector 1.

As illustrated in the front view of FIG. 3A, the stopper 3 is substantially formed into disc and made of elastic metal, for example, stainless metal for spring. Cut-off portions 13, 13, . . . , are formed alternatively on the inner peripheral surface and the outer peripheral surface of the stopper 3, radiating in all directions, in such a way that the depth of the cut-off portions on the inner surface comes across zigzag with the depth of those on the outer surface. The inner peripheral portion serves as a supporting portion 3a for supporting the coaxial cable 7 and the outer peripheral portion serves as a fastening portion 3b for fastening itself to the main body of the connector 1. Formation of the cut-off portions 13 makes the stopper 3 elastic in diameter direction. The inner diameter of the stopper 3 is formed in a smaller size than the outer diameter of the cable 7 to be inserted, and the inner peripheral portion thereof is provided with radius in accordance with the diameter of the cable so that the distal end of the supporting portion 3a may make line contact with the cable 7.

By making the stopper into line contact with the cable, it is possible to support the cable more assuredly and improve the locking force more than the conventional stopper (for example, FIG. 1 of Japanese Patent publication of unexamined application No. 2002-184536) in which the sharp distal end bites into the cable.

Even if the distal end of the supporting portion 3a is cut off in a straight line without providing radius, it is possible to make line contact with the cable and support it favorably.

As illustrated in the section view taken along the line B-B in FIG. 3B, the supporting portion 3a is bent toward the inner direction of the main body of the connector 1 at about 45° of the bent angle θ and the whole stopper 3 is formed in substantially cone shape with the front portion narrower.

By bending as the above, the stopper 3 becomes elastic in diameter and in combination with the function of shrinkage, the supporting portion 3a expands easily in diameter at a time of inserting operation of the cable, thereby smoothing the inserting operation. When a drawing stress is applied to the inserted cable, the supporting portion assuredly bites into the cable, thereby preventing dropping out the cable. Further, since the end portion 3c of the fastening portion 3b of the stopper 3 is abutted against the inner peripheral portion 14e prior to a stepped portion 14a of a fixed sleeve 14 so as to hinder the movement, the outer periphery doesn't expand and even if a large drawing stress is applied to the cable, the bent angle θ of the supporting portion 3a of the stopper 3 is maintained, with a favorable supporting operation.

When manufacturing the stopper, the cut-off portion 13 and the supporting portion 3a are made by punching out and then, the supporting portion 3a is bent. Favorably, the supporting portion 3a is cut off, starting from the front (the left side in FIG. 3B). Thus, the rear end portion of the supporting portion 3a (the inner peripheral end portion at the left side in FIG. 3B) coming into contact with the cable 7 is formed into an acute angle, thereby enabling the assured support of the cable 7. In FIG. 3, although sixteen cut-off portions are respectively provided on the inner peripheral side and the outer peripheral side, it is possible to change the number easily by changing the width of the cut-off portion. Namely, it is possible to change the number of the supporting portions 3a and the fastening portions 3b.

The stopper 3 enables the cable to be inserted into the main body of the connector and fixed therein when at least the supporting portions 3a have elastic property in diameter even if the whole stopper doesn't have elastic property in diameter. Therefore, the cut-off portions 13 can be removed from the outer peripheral surface.

The stopper 3 formed thus is fixed to the anchor 4 and then arranged in the main body of the connector 1. The anchor 4 consists of the fixed sleeve 14 for fastening it to the main body of the connector 1 and the fixed ring 15 for fastening the stopper 3 to the fixed sleeve 14 and the fixed sleeve 14 has the stepped portion 14a for blocking the stopper 3 inwardly and the releaser inserting portion 14b. The fixed ring 15 is formed with the same diameter as the stopper 3. The stopper 3 is fixed to the anchor 4 by inserting the stopper 3 from the front side to a fixed position of the fixed sleeve 14 as well as inserting the fixed ring 15, and the diameter of the end opening portion of the fixed sleeve 14 is shrunken by press. Thus, the fixed ring 15 can be prevented from falling out and the stopper 3 can be fixed within the anchor 4.

By pressing the anchor 4 with the stopper 3 fixed there from the rear portion of the main body of the connector 1, the stopper 3 is built into the main body of the connector 1.

The releaser 5 is formed by a cylindrical sliding portion 5a sliding around the cable 7 and a brim-shaped operating portion 5b, provided in the back of the sliding portion 5a, for operating the sliding portion 5a. The sliding portion 5a has the length ranging from the rear portion of the fixed sleeve 14 to the stopper 3 and its distal end is formed into an acute angle with a tapering surface providing a fitting portion 5d abutting on the supporting portion 3a of the stopper 3 as illustrated in the enlarged view of A of FIG. 1. The outer periphery of the sliding portion 5a has a stepped portion 5c to be engaged in a projection 14c formed on the releaser inserting portion 14b of the fixed sleeve 14, so that the projection 14c can prevent fall-out of the inserted releaser 5.

The operating portion 5b is positioned in the back of the main body of the connector 1 and by pressing the operating portion 5b forward, the sliding portion 5a slides and the end operating portion 5d presses the supporting portion 3a forward. As a result, the supporting portion 3a expands in diameter and the supporting portion 3a is floated up from the cable 7. Thus, the cable 7-supporting function by the stopper 3 is released and namely, the blocking function is released.

Next, the procedure of assembling the connector and attaching the connector to the cable will be described. At first, a ring-shaped joint 10 including the sleeve 6 is inserted into the main body of the connector 1 from backward. At this time, the ring-shaped joint 10 is integrated with the connector by press or the like. After fitting the nut 2 into the cylindrical fitting portion 8, the fitting portion 8 is expanded in diameter, hence to joint the nut 2 with the main body of the connector 1 in a rotatable way.

Then, as described above, the stopper 3 fixedly supported by the fixed sleeve 14 and the fixed ring 15 is inserted into the main body of the connector 1 and the releaser 5 is inserted, hence to complete the connector.

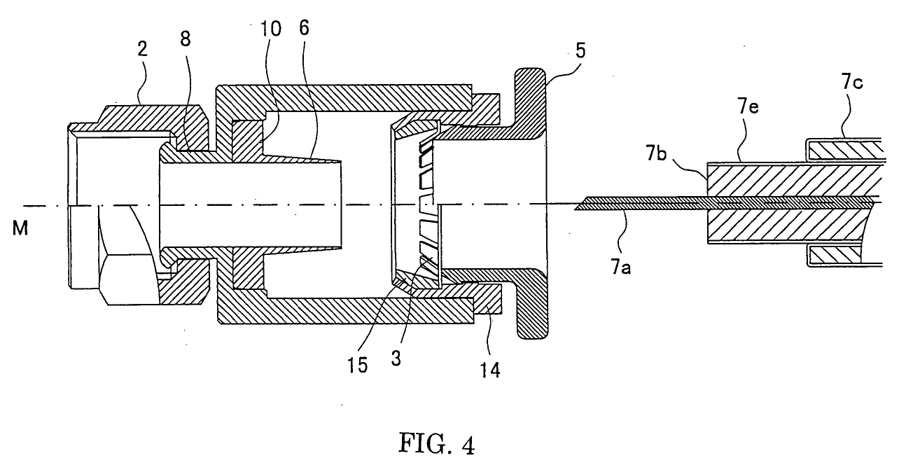

The operation of attaching the cable 7 will be executed as follows. The end portion of the cable 7 to be inserted is at first processed. More specifically, as illustrated in FIG. 1 (or FIG. 4 described later), the inner insulator 7b and the protective covering 7d are cut off so as to bare the central conductor 7a and the inner insulator 7b in a predetermined length, and the outer conductor 7c is rolled up on the protective covering 7d. Then, the cable 7 may be inserted into the main body of the connector 1 from backward.

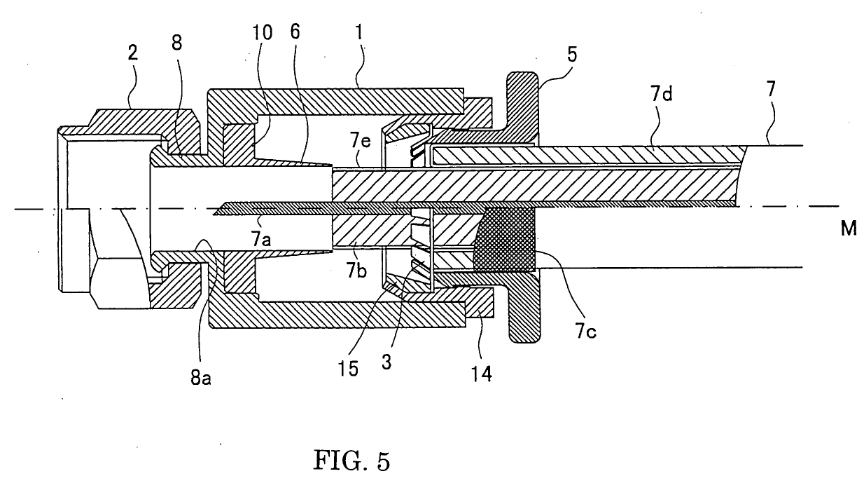

FIG. 4 shows the state before inserting the cable into the connector, FIG. 5 is an explanatory side view showing the state on the way of inserting the cable, and the state after inserting the cable is as shown in FIG. 1. The cable 7 is inserted into the main body of the connector 1 up to the back surface of the front portion of the main body 1, more specifically, up to a predetermined position of abutting on the ring-shaped joint 10. Thus, the sleeve 6 penetrates between the inner insulator 7b and the outer conductor 7c and surely provides electrical contact between the outer conductor 7c and the main body of the connector 1 through the sleeve 6, and the strip-shaped projections 11 formed around the sleeve 6 hinder the easy rotation of the cable 7 even if the rotation stress is applied, which keeps a favorable connection state.

The supporting portion 3a works to support the cable 7 assuredly as mentioned above. Further, the distal end of the central conductor 7a protrudes to the end of the nut 2, and the central conductor of the cable 7 is positioned at the central axis (M) of the nut 2, hence to obtain the central conductor of the connecting means.

In FIG. 4 and FIG. 5, the reference numeral 7e indicates aluminum foil. The outer conductor of the coaxial cable is generally formed by the mesh conductor (the above mentioned outer conductor 7c) and the aluminum foil 7e provided therein, when having the aluminum foil 7e as mentioned above, upon processing the end portion of the cable, the aluminum foil 7e is attached to the inner insulator 7b without being rolled up and the sleeve 6 comes through between the aluminum foil 7e and the mesh conductor (the above mentioned outer conductor 7c).

As mentioned above, the coaxial cable inserted into the connector is prevented from the fall-out, with stable attachment, even if the drawing stress is applied to the connector, because of the function of the stopper. On the other hand, the operation of the releaser can release the blocking function by the stopper so as to pull out the cable from the connector easily, and therefore, cable can be exchanged easily. When the end of the coaxial cable is processed into a predetermined shape and then inserted into the main body of the connector, the connector portion will be completed after attachment of the connector, so that attachment of the connector becomes easy. Moreover, the removed connector can be recycled usefully.

Since the whole stopper has elastic property in diameter, it is possible to insert the cable smoothly and prevent the rotation of the attached cable because the strip-shaped projections are formed on the sleeve. In addition, it is unnecessary to provide rotation-stopping means separately, hence to maintain a favorable connection state.

Further, since the releaser has the simple structure and form, the structure of the connector is not complicated, and since the connecting means can be realized by a plug, it can be connected to a receptacle terminal of an electronic device and the like.

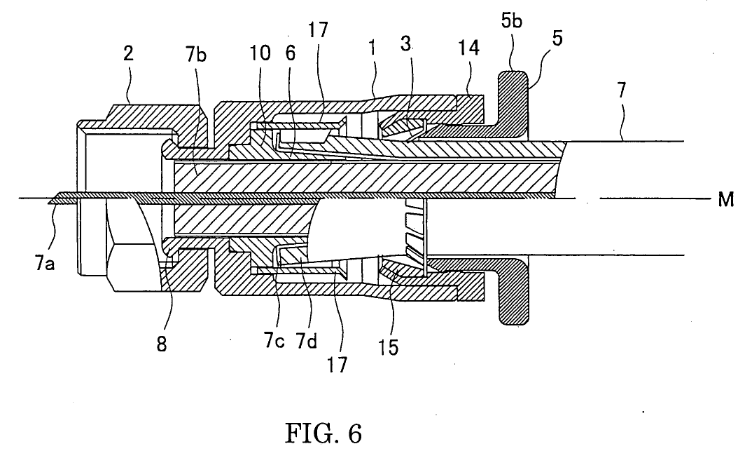

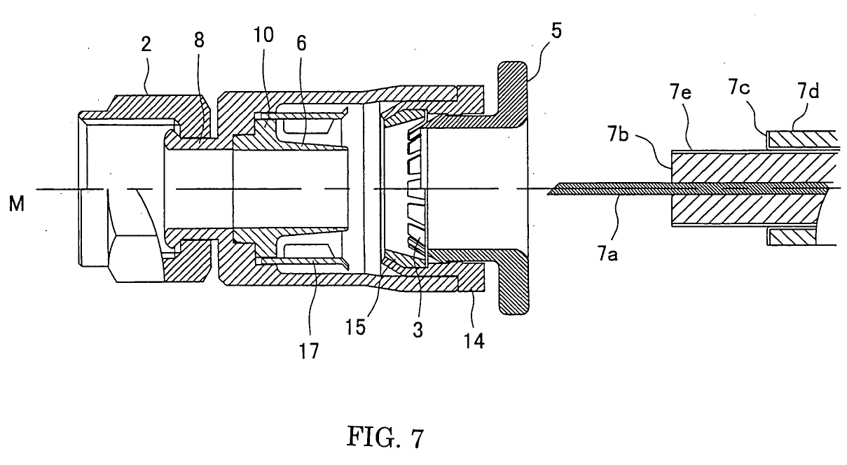

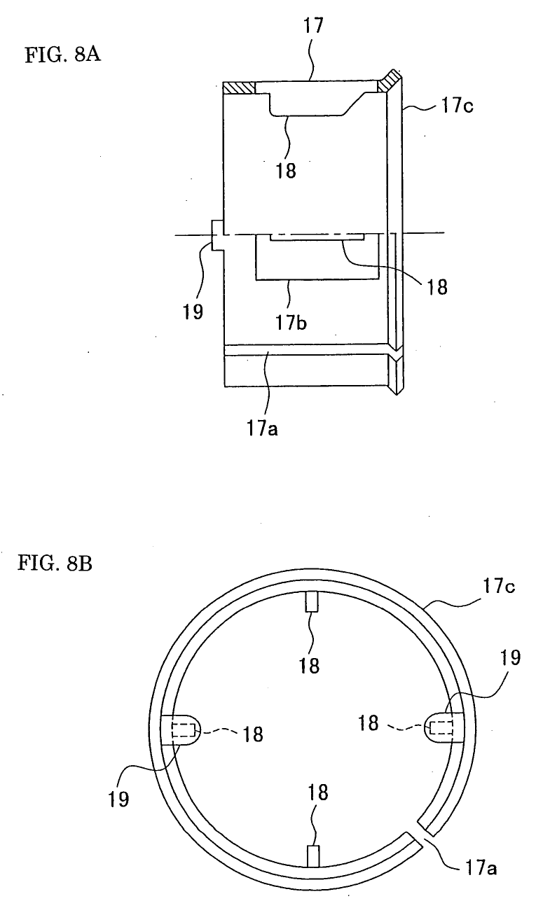

A second embodiment of the connector according to the invention will be described with reference to FIGS. 6 to 8. FIG. 6 and FIG. 7 are side views of the connectors each showing an important portion in cross section; FIG. 6 shows the state of connecting the coaxial cable and FIG. 7 shows the state before connecting the coaxial cable. It is different from FIG. 1 in that the second embodiment is provided with a latch 17 dedicated as the rotation-stopping means within the main body of the connector 1, and FIG. 8 shows the latch 17; FIG. 8A is a side elevation view of the latch and FIG. 8B is a front view of the latch. The same reference numeral is attached to the same component as that of FIG. 1 and its description is omitted.

Hereafter, the latch 17 will be described. As illustrated in FIG. 7, the latch 17 is formed into a cylinder having the same length as the sleeve 6. As illustrated in FIG. 8, a slit 17a is arranged so as to change the diameter, the whole latch is formed elastically in the direction of diameter by using the stainless metal for spring, and further latching blades 18 are punched out at four positions in the periphery.

The reference numeral 17b indicates an opening bored in order to form the latching blade 18, and the latching blade 18 is bent inwardly at one side of the opening 17b and formed into a strip shape in parallel with the connector central axis M that is the central axis. The distal end to bite into the coaxial cable 7 is formed into an acute angle when punching out, thereby easily biting into the protective covering 7d of the coaxial cable 7. The protruding amount of the latching blade 18 is set in a way of making the interstice between the sleeve 6 and itself when attaching the cable to the main body of the connector 1 in a determined space narrower than the thickness of the protective covering 7d of the coaxial cable 7 to be inserted, and the rear end portion 17c at the side of inserting the coaxial cable 7 is expanded so as to make the coaxial cable 7 easily enter.

Projections 19 for engaging into the ring-shaped joint 10 are provided at two opposed positions on the front surface of the latch 17 and concave portions (not illustrated) to be engaged into the projections 19 are provided on the ring-shaped joint 10 at the corresponding two positions.

The latch 17 thus formed is also assembled at an assembling time of the ring-shaped joint 10, one distal end of the latch 17 is blocked by the main body of the connector 1, and jointed with the connector. This makes the latching blade 18 bite into the protective covering 7d of the inserted coaxial cable 7. The coaxial cable 7 to be inserted is processed in a little different way from that of the first embodiment as mentioned above; as illustrated in FIG. 7, the outer conductor 7c is not rolled up on the protective covering 7d but it is cut off at the cutting position on the protective covering 7d and inserted.

Thus, the latch can prevent rotating of the coaxial cable. Especially, by disposing the latch so as to cover the sleeve, when the sleeve goes through between the inner insulator and the outer conductor and the protective covering is rolled up around the sleeve, the latching blade assuredly bites into the protective covering. Accordingly, it can prevent the rotation of the coaxial cable assuredly. However, since the latch has elastic property, even if the protective covering is plastically deformed with time, the rotation-stopping function of the coaxial cable can be maintained.

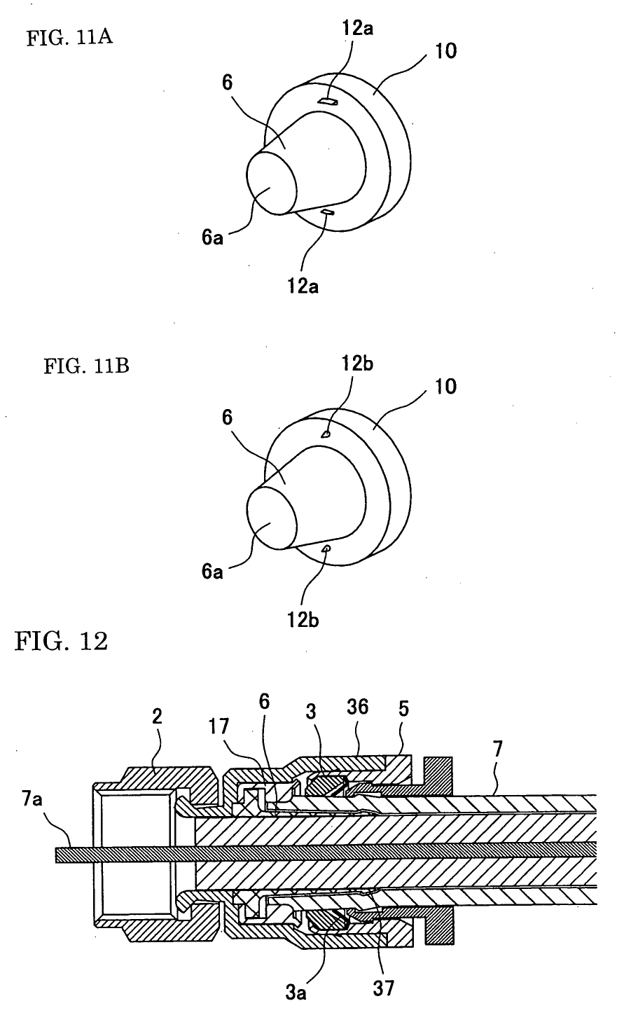

Although the rotation-stopping means is realized by the strip-shaped projections 11 provided on the sleeve in the above embodiments, projection pieces 12a and 12b may be provided on the ring-shaped joint 10 abutting on the end of the cable 7, as illustrated in FIG. 11. In FIG. 11A, projection pieces 12a of horizontally-long sharp edge may be provided at two positions, and in FIG. 11B, needle-shaped projections 12b are provided. When the rotation-stopping means is formed in these shapes, they are effective in preventing the rotation of the cable. Moreover, when providing with the strip-shaped projections 11 in addition to the above projection pieces 12a and 12b, it is more effective.

Although four latching blades 18 are provided on the latch 17 in the second embodiment, rotation can be prevented effectively only by two latching blades provided at the opposed positions, or only one latching blade could prevent rotation. Further, according as the degree of the latching blade 18 biting into the protective covering 7d is larger, it is more effective in preventing rotation of the cable. However, when it is too large, the protective covering 7d may be cut off and broken, and when it is too small, the rotation-stopping function may be small. Therefore, preferably it is in the range of 10% to 20% of the thickness of the protective covering 7d.

Further, as illustrated in FIG. 16, the sleeve 6 of the second embodiment may be formed, with improvement in blocking function of the inserted coaxial cable. FIG. 16 is a side lateral view of the sleeve 6 including the ring-shaped joint 10; FIG. 16A shows the structure of the sleeve 6 around which a plurality of latch rings 34 are provided having sharp edge toward the front of the connector in order to provide a blocking function and FIG. 16B shows the structure of the sleeve 6 having a mesh-shaped groove, what is called, a knurl 35 in order to provide the blocking function. In case of having the latch 17, it is effective to provide the sleeve the processing for the blocking function, without providing the projections 11 as illustrated in FIG. 2. Especially, in case of the knurl 35, it is effective in preventing the rotation of the coaxial cable and removing the oxide film attached to the outer conductor 7c of the coaxial cable, with more assured electrical connection. This processing for blocking can be applied to the sleeve of the other embodiments.

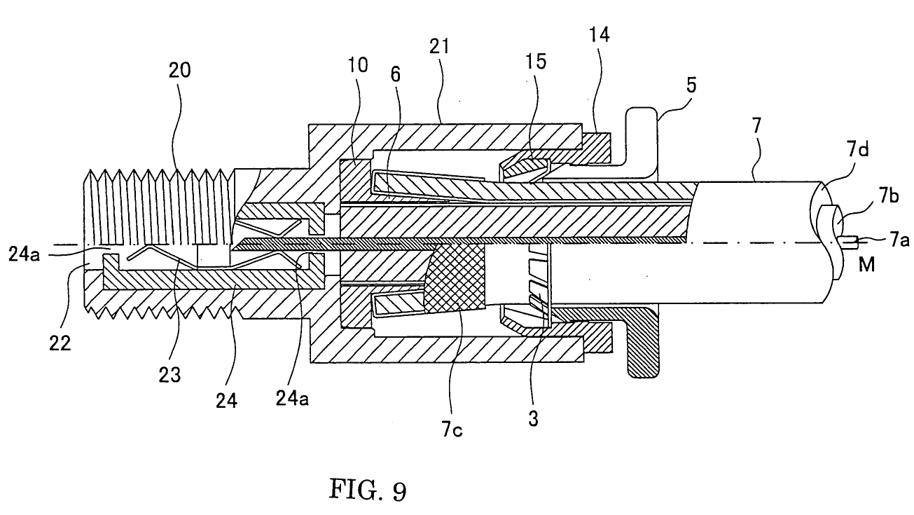

A third embodiment of the connector according to the invention will be described with reference to FIG. 9. FIG. 9 is a side lateral view showing an important portion in cross section. It is different from that of FIG. 1 in that the connecting means is a receptacle including a male-screwed bolt 20. The same reference numeral is attached to the same component as that of FIG. 1, and the description thereof is omitted.

The bolt 20 includes a communicating hole 22 which communicates with the through hole 6a of the sleeve 6 within the main body of the connector 21, where the central conductor (not illustrated) of the connecting object is inserted on the central axis M. Within the connecting hole 22, a fitting metal 23 is provided for jointing the central conductor 7a of the cable 7 inserted into the main body of the connector 21, with the central conductor (not illustrated) of the connector of the connecting object. The fitting metal 23 is arranged within a cylindrical supporter 24 made of resin and the cylindrical supporter 24 has apertures 24a through which the central conductor penetrates on the front and back surfaces thereof respectively.

This connector is assembled at first by inserting the cylindrical supporter 24 with the fitting metal 23 built-in, into the bolt 20 from the back of the main body of the connector 21 and then inserting and pressing the ring-shaped joint 10 including the sleeve 6 from backward. Similarly to the first embodiment, the releaser 5 and the stopper 3 supported by the fixed sleeve 14 and the fixed ring 15 are assembled.

The procedure of attaching the cable 7 is the same as that in the first embodiment. The cable 7 whose end is processed into a predetermined shape is inserted into the main body of the connector 21 and assuredly attached thereto and it will never be fallen out even if a drawing stress is applied. The central conductor 7a of the inserted cable 7 is inserted into the cylindrical supporter 24 and clamped by the fitting metal 23.

Thus, by forming the connecting means as the receptacle, a plug as mentioned in the first embodiment can be connected, the both connected central conductors are jointed by the fitting metal 23, and the both outer conductors are jointed through the bolt 20, thereby establishing a good connection of the cables. Similarly to the first embodiment, it is possible to attach the cable to the connector assuredly and pull out the cable therefrom by operating the releaser.

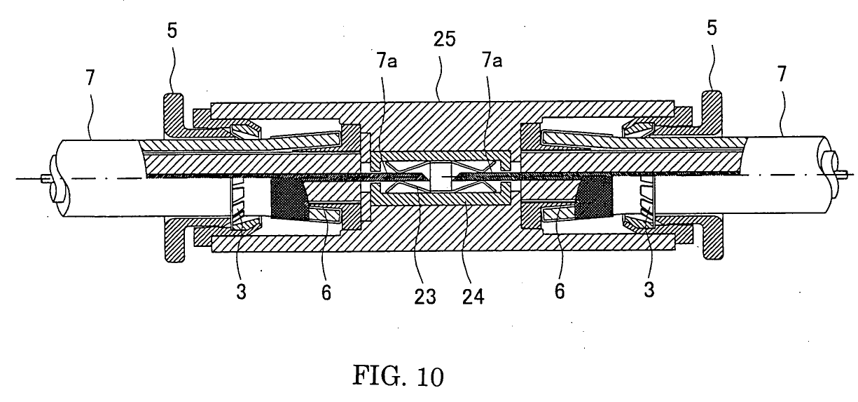

FIG. 10 shows another form of the connector according to the invention. Of the components of FIG. 9, the bolt as the connecting means is formed in the same shape as that of the main body of the connector and a cable can be directly attached there. The same reference numeral is attached to the same component as that of FIG. 9 and the description thereof is omitted.

As illustrated in FIG. 10, a fitting metal 23 for jointing the both central conductors 7a and 7a is arranged in the central portion, a connector cylinder 25 with the main bodies of the connector 21 as shown in FIG. 6 opposed at the both sides, and they are integrated as a whole. The above-mentioned sleeve 6, stopper 3, and releaser 5 are assembled symmetrically within the connector cylinder 25.

Because of the above structure, a cable relay connector can connect both cables directly and an easy connection can be obtained only by cutting off the end of the cable into a predetermined shape and inserting it into the connector. Further, the cable can be pulled out easily by operating the releaser.

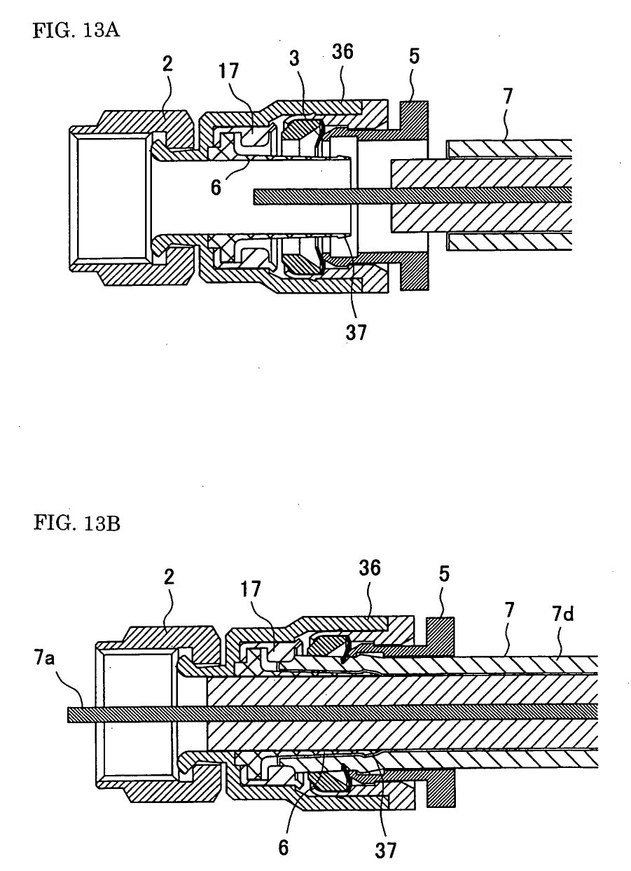

FIGS. 12 and 13 shows across sectional view of a connector of the present invention according to a fourth embodiment. FIG. 12 shows a state in which a coaxial cable is inserted, and FIG. 13A shows a state before insertion of a coaxial cable, and FIG. 13B shows a state in which drawing stress is applied to the inserted coaxial cable. The fourth embodiment is quite different from the first embodiment about positional relationship between the stopper 3 and the sleeve 6. The elements which are the same as that in FIG. 1 are denoted the same reference numbers and explanation thereof will be omitted.

As shown in the above drawings, the stopper 3 is moved forward (the left direction in the drawings) and disposed, and the rear end of the sleeve 6 protrudes the supporting portion 3a of the stopper 3 to be positioned behind the stopper 3. As a result, the entire length of the main body of the connector 36 is shortened compared to the first embodiment. Moreover, at the rear end of the sleeve a ring-shaped projection 37 is provided so as to be located just behind the supporting portion 3a of the stopper 3.

In addition, as shown in FIG. 6, the latch 17 is provided. In this case, the latch 17 is made to be shorter than the sleeve 6 so as not to interfere with the stopper 3.

In this way, with the stopper surrounding the sleeve, eve if a coaxial cable with a small diameter is inserted due to an inconsistent diameter of a coaxial cable, an inner diameter of the protective covering at a portion supported by the stopper can be maintained at a predetermined size since the inner diameter is expanded by the sleeve. As a result, a diameter of the portion supported by the stopper is not narrowed, and thus it is possible to support the protective covering preferably. In addition, even if a coaxial cable with a different diameter is used, power to pull out the coaxial cable (that is, drawing stress) can be maintained over 245N, for example, resulting that the coaxial cable is not fallen out. Moreover, with the stopper surrounding the sleeve, the entire length of the main body of the connector can be shortened.

Moreover, as shown in FIG. 13B, the ring-shaped projection 37 provided with the sleeve. It expands the protective covering 7d at the backside of the stopper 3, particularly just behind the supporting portion by the stopper 3, so that the locking force is improved and the fall-out of the coaxial cable is prevented assuredly.

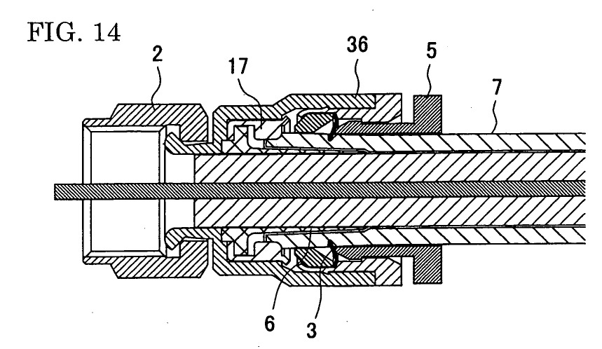

FIG. 14 shows a cross sectional view of a modification of the connector in FIG. 12. Similar to the first embodiment, the sleeve 6 is formed in a conically-shape, having a wall thickness tapering down backwardly from the front portion.

In this way, even if no ring-shaped projection is provided with the sleeve, coaxial cables with various diameters can maintain a stable locking force with the stopper surrounding the sleeve.

Although the main bodies of the connectors 1 and 21 and the connector cylinder 25 are formed in a cylindrical shape in the above-mentioned embodiments, they may be formed into the other shape, for example, a hexagonal tube. The connecting means may be formed in any other structure than the structure of the above plug and the above receptacle and as long as the cable-attaching means within the main body of the connector has the above structure, good blocking function can be secured.

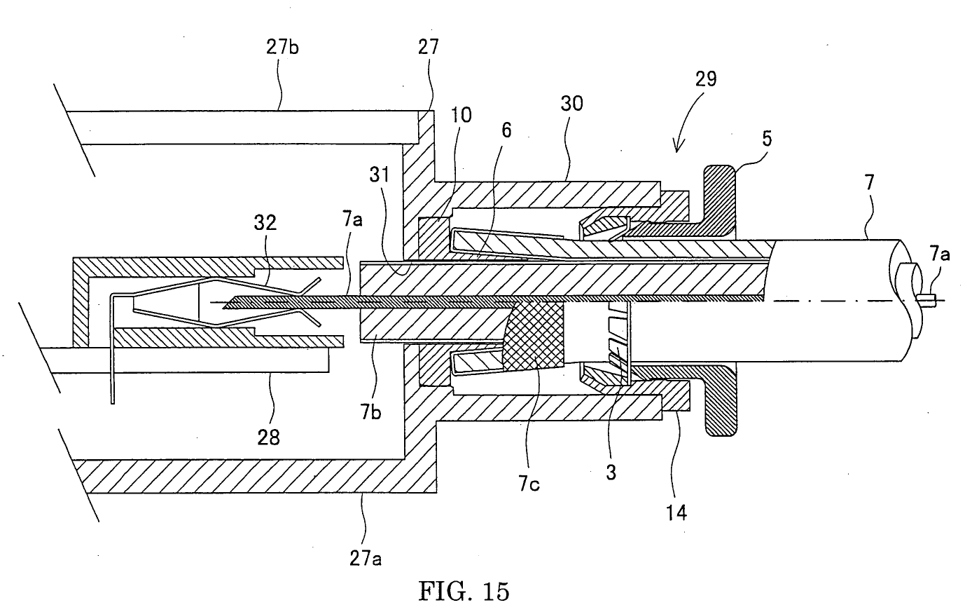

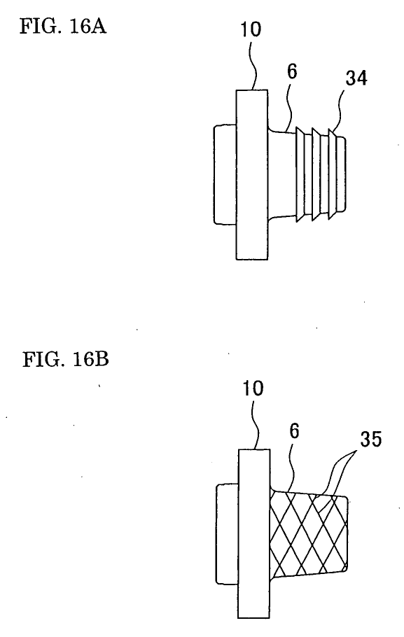

FIG. 15 shows one example of an electronic device case (hereinafter, referred to as a case simply) according to the invention. FIG. 15 is an explanatory view of a cross section, the reference numeral 27 indicates a case, the reference numeral 28 indicates a circuit board arranged within the case, and the reference numeral 29 indicates a connector for inserting the coaxial cable therein. The same reference numeral is each attached to the same component as that of FIG. 1 and the description thereof is omitted.

The case 27 is formed by a main body 27a and a cover plate 27b, they are made of metal, and the inside is shielded from electromagnetic force. A connector 29 for connecting the cable is formed on the side surface of the main body 27a. The connector 29 is formed by providing a protrusion on the cylindrical main body of the connector 30 and providing the same cable-attaching means as that of FIG. 1 therein.

On the other hand, the wall surface of the main body 27a corresponding to the distal end of the connector 29 includes a communicating hole 31 for introducing the central conductor 7a and the inner insulator 7b of the connected coaxial cable 7 into the inside of the case 27, and the central conductor 7a of the cable 7 inserted into the main body of the connector 30 extends into the inside. A fitting metal 32 for jointing the central conductor 7a is arranged on the circuit board 28 disposed within the case 27 in accordance with the position of the central conductor 7a on the central axis M of the inserted cable 7, and the connecting means is formed on this circuit board 28.

Thus, by providing the same coaxial cable-attaching means as the connector in the case, the inserted cable can be assuredly attached according to the function of the stopper, without falling out even if a drawing stress is applied. By operating the releaser, the blocking function according to the stopper can be released and the cable can be pulled out easily, thereby making the work of exchanging cables easy. Further, since the cable can be attached to the case only by processing the end of the cable into a predetermined shape and inserting it into the main body of the connector, there is no need to attach a connector to the cable separately and a connection can be established in a simple structure.

Since the whole stopper has elasticity in diameter, cable can be inserted there smoothly and because of the strip-shaped projections formed on the sleeve, the inserted cable can be prevented from rotation without providing any extra rotation-stopping means and kept in a favorable connection state.

Further, since the releaser has the simple structure and shape, the structure of the cable-attaching means becomes also simple.

Although the main body of the connector 30 is outwardly protruded from the case 27 in this embodiment of the case for the electronic device, it may be inwardly protruded within the case 27 in the counter direction and then, the coaxial cable-attaching means may be formed within the case. Although the inside space becomes narrower, the bare portion of the cable connecting portion can be shortened, the connecting portion can be stabler, and the appearance is improved. Although the connecting means is attached on the circuit board, the fitting metal 32 may be attached on the side of the main body of the connector 30.

Moreover, the configuration of the connector of the fourth embodiment as shown in FIGS. 12 to 14, in which the stopper 3 is provided so as to surround the sleeve 6, is also suitable for an electronic device case. In this configuration, even if a coaxial cable with a different diameter is used, the stopper 3 can support the coaxial cable preferably and power to pull out the coaxial cable can be maintained over a predetermined value. Further, this configuration makes it possible to shorten the entire length of the main body of the connector.

Although the releaser is provided in every embodiment in order to have a release function, when it is used in a portion requiring no release function, it is not necessary to provide the releaser, whereby a stable connector in which the inserted cable is not fallen out can be formed at a low cost.

What is claimed is:

1. A connector for coaxial cable having a cylindrical main body into which a coaxial cable is inserted and connecting means provided in front of the main body to connect the main body with a connecting object,
wherein the main body includes a sleeve penetrating between an inner insulator and an outer conductor of the coaxial cable to be inserted and a stopper for preventing a fall-out of the coaxial cable therein,
the stopper is formed in substantially cone shape with the front portion narrower, in which an inner peripheral portion of the distal end thereof serves as a supporting portion for supporting the circumference of the coaxial cable, and an outer peripheral portion of the distal end thereof serves as a fastening portion to fasten the stopper within the main body of the connector, and at least the supporting portion has elastic property in diameter, and
the supporting portion supports the coaxial cable and prevents the fall-out of the coaxial cable when an end of the coaxial cable is inserted into the main body of the connector from backward.

2. The connector for coaxial cable according to claim 1,
wherein the supporting portion of the stopper is formed in such a way that the distal end thereof makes a line contact with the coaxial cable.

3. The connector for coaxial cable according to claim 1, comprising:
a releaser for releasing the stopper's locking force toward the coaxial cable, including a cylindrical sliding portion for covering the coaxial cable and an operating portion for operating the sliding portion, in which a distal end of the sliding portion abuts on the supporting portion of the stopper and pushes up the supporting portion by sliding the sliding portion forward, hence to release a supporting operation of the coaxial cable.

4. The connector for coaxial cable according to claim 1,
wherein processing for blocking the coaxial cable is performed on a periphery of the sleeve.

5. The connector for coaxial cable according to claim 1, comprising:
a rotation-stopping means which prevents rotation of the inserted coaxial cable.

6. The connector for coaxial cable according to claim 5,
wherein the rotation-stopping means is a strip-shaped projection longitudinally formed on the side surface of the sleeve, which prevents rotation of the inserted cable.

7. The connector for coaxial cable according to claim 1,
wherein the, rear end of the sleeve is located posterior to the supporting portion of the stopper.

8. The connector for coaxial cable according to claim 7,
wherein ring-shaped projections are formed at the back of the sleeve for blocking the coaxial cable.

9. The connector for coaxial cable according to claim 6,
wherein the rotation-stopping means is a cylindrical latch through which the inserted coaxial cable penetrates, the cylindrical latch is arranged so as to cover the sleeve and includes the front portion engaged into the main body of the connector and has elastic property in diameter, and a latching blade is provided in its inner surface for biting into the circumference of the coaxial cable, and
the latching blade is arranged in parallel with a central axis of the connector and toward the above central axis, hence to bite into the circumference of the inserted coaxial cable and prevent rotation of the coaxial cable.

10. The connector for coaxial cable according to claim 9,
wherein the latching blade protrudes such that it bites into a protective covering of the inserted coaxial cable by 10 to 20% of thickness of the protective covering.

11. The connector for coaxial cable according to claim 1,
wherein the connecting means is a nut female-screwed on the inner surface, and a cylindrical fitting portion on which the nut is fit protrudes in front of the main body of the connector in order to support the rear portion of the nut in a rotatable way, and in the cylindrical fitting portion a through hole is provided through which the inner insulator and the central conductor of the inserted coaxial cable penetrate in series with a through hole of the sleeve, and the central conductor of the inserted coaxial cable protrudes from the through hole to be arranged on the central axis of the nut.

12. The connector for coaxial cable according to claim 1,
wherein the connecting means is a male-screwed bolt integrated with the main body of the connector, and on the central axis of the bolt a communication hole is formed for jointing the central conductor of the coaxial cable attached to the main body of the connector with the central conductor of the connecting object, and a fitting metal for jointing and supporting the both central conductors is arranged within the communication hole.

13. The connector for coaxial cable according to claim 1,
wherein the connecting means is formed symmetrically with the main body of the connector, the two main bodies are opposed to each other and integrated into one body, the sleeves and the stoppers are also arranged within the both main bodies symmetrically, and a fitting metal for jointing the both central conductors of the coaxial cables inserted into the both main bodies with each other is arranged in the middle portion.

14. An electronic device case having a connector for coaxial cable attached from outside,
wherein the connector for coaxial cable has a cylindrical main body of connector into which the coaxial cable is inserted, including a sleeve inserted between an inner insulator and an outer conductor of the coaxial cable to be attached and a stopper for preventing the fall-out of the coaxial cable,
the stopper is formed in substantially cone shape with the front portion narrower, in which an inner peripheral portion of the distal end thereof serves as a supporting portion for supporting the circumference of the coaxial cable, and an outer peripheral portion of the distal end thereof serves as a fastening portion to fasten the stopper within the main body of the connector, and at least the supporting portion has elastic property in diameter, and
when inserting an end of the coaxial cable into the main body of the connector from backward, the cable is attached to the case and the supporting portion supports the coaxial cable, hence to prevent the fall-out of the coaxial cable.

15. The electronic device case according to claim 14,
wherein the supporting portion of the stopper is formed in such a way that the distal end thereof makes a line contact with the coaxial cable.

16. The electronic device case according to claim 14, comprising:
a releaser for releasing the stopper's locking force of the coaxial cable, including a cylindrical sliding portion for covering the coaxial cable and an operating portion for operating the sliding portion, in which a distal end of the sliding portion abuts on the supporting portion of the stopper and pushes up the supporting portion by sliding the sliding portion in a direction of the case, hence to release a supporting operation of the coaxial cable.

17. The electronic device case according to claim 14, further comprising a rotation-stopping means for preventing rotation of the inserted coaxial cable on at least one of the sleeve and an abutting surface of the main body of the connector abutting on the inserted coaxial cable.

18. The electronic device case according to claim 17,
wherein the rotation-stopping means is a strip-shaped projection longitudinally formed on the side surface of the sleeve in a direction of axis of the sleeve, which prevents rotation of the inserted cable.

19. The electronic device case according to claim 14,
wherein the rear end of the sleeve is located posterior to the supporting portion of the stopper.

20. The electronic device case according to claim 19,
further comprising ring-shaped projections formed at the back of the sleeve.
